(19) United States
(12) Patent Application Publication
(10) Pub. No.: US 2009/0185369 A1
(43) Pub. Date: Jul. 23, 2009

(54) FLASHLIGHT HEAD WITH PRECISE FOCUS

(76) Inventors: Su-Chang LIAO, Taichung City (TW); Di-Shun Liao, Taichung City (TW)

Correspondence Address: Chien-Hui Su, P. O. Box 70-121 Taichung, Taichung City, 40899, TW

(21) Appl. No.: 12/018,789

(22) Filed: Jan. 23, 2008

(51) Int. Cl. F21L 4/04; F21V 11/00

(52) U.S. Cl. 362/205; 362/240

(57) ABSTRACT

A flashlight head connected electrically to a battery is positioned within a housing at a front end thereof and locked by a light-transmissible front cap. The flashlight head includes a project barrel and a control base. A reflector is disposed at a front end of the project barrel and a light source portion of the reflector is mounted on a positioner. An opening is disposed at a center of the positioner. A luminous body passes through the opening and extends into a center of the light source portion of the reflector. The luminous body has a positive electrode pin and a negative electrode pin, and each of the positive electrode pin and the negative electrode pin extends onto the positioner. A cooling plate is adhered to a back side of the luminous body. Two slots form on the cooling plate and are disposed corresponding to the positive electrode pin and the negative electrode pin. A switch is mounted on the control base and positioned corresponding to a button on the housing. A circuit board is mounted on one end of the control base and has a positive electrode conductor and a negative electrode conductor positioned corresponding to the positive electrode pin and the negative electrode pin of the luminous body respectively. The positive electrode conductor and the negative electrode conductor pass through the slots of the cooling plate and connect electrically to the positive electrode pin and the negative electrode pin of the luminous body respectively while the control base assembles with the project barrel. The luminous body is controlled by the circuit board and the switch. The luminous body is disposed in the center of the project barrel and the center of the light source portion of the reflector, i.e. the focus of the flashlight, so the flashlight is assembling without calibrating the focus. The efforts of assembling easily and quickly and high quality are reached.

### FIELD OF THE INVENTION

The present invention relates to flashlights and more particularly to a structure of flashlight head without calibrating a focus, in that a flashlight head with precise focus is obtained.

### BACKGROUND OF THE INVENTION

As the progress of the semiconductor technology, the super high brightness Light-Emitting Diode (LED) is used in the flashlight broadly. Due to the high temperature produced by the super high brightness LED the use of cooling board (plate) is necessary for keeping working normally in a long period. Hence the super high brightness LED module with the cooling plate is the must commonly used in the flashlight.

However, in those flashlight head the LED module is mounted on the circuit board directly and aligned with the reflector manually. Because the PC printed circuit board is the single part, there is a tolerance while assembling with the other part. And the LED is mounted on the circuit board, there is a position tolerance. When producing the flashlight, the position of the LED at the center of reflector is not the precise focus position. Therefore to keep the good quality of flashlight the calibrating procedure is needed. And in some prior arts the wires are designed to connect the pin of LED with the circuit board by detouring the cooling plate. It is not easy to assemble and will exist the possibility that the pins fall off. Thus there is an eager demand for a novel design which can improve the defect in the prior art.

### SUMMARY OF THE INVENTION

Accordingly, the primary object of the present invention is to provide a flashlight head with precise focus. The flashlight head connected electrically to a battery is positioned within a housing at a front end thereof and locked by a light-transmissible front cap. To The flashlight head includes a project barrel and a control base. A reflector is disposed at a front end of the project barrel and a light source portion of the reflector is mounted on a positioner. An opening is disposed at a center of the positioner. A luminous body passes through the opening and extends into a center of the light source portion of the reflector. The luminous body has a positive electrode pin and a negative electrode pin, and each of the positive electrode pin and the negative electrode pin extends onto the positioner. A cooling plate is adhered to a back side of the luminous body. Two slots form on the cooling plate and are disposed corresponding to the positive electrode pin and the negative electrode pin. A switch is mounted on the control base and positioned corresponding to a button on the housing. A circuit board is mounted on one end of the control base and has a positive electrode conductor and a negative electrode conductor positioned corresponding to the positive electrode pin and the negative electrode pin of the luminous body respectively. The positive electrode conductor and the negative electrode conductor pass through the slots of the cooling plate and connect electrically to the positive electrode pin and the negative electrode pin of the luminous body respectively while the control base assembles with the project barrel. The luminous body is controlled by the circuit board and the switch. The luminous body is disposed in the center of the project barrel and the center of the light source portion of the reflector, i.e. the focus of the flashlight, so the flashlight is assembling without calibrating the focus. The efforts of assembling easily and quickly and high quality are reached.

Another object of the present invention is to provide a flashlight head with precise focus. An entry of a light source portion of the reflector inside a project barrel is mounted on a positioner. An opening forms at a center of the positioner for assembling a luminous body extending into the entry of the light source portion. A mounting frame disposed around the opening has a shape corresponding to the luminous body for positioning the luminous body and providing an effort of assembling easily and precisely.

Yet another object of the present invention is to provide a flashlight head with precise focus. An opening forms at a center of a positioner inside a project barrel for assembling a luminous body. The positioner comprises two installing surfaces positioned corresponding to a positive electrode pin and a negative electrode pin of the luminous body respectively. The installing surfaces position the positive electrode pin and the negative electrode pin respectively while the luminous body is mounting in the opening for ensuring the positive electrode pin and the negative electrode pin positioned corresponding to two slots of a cooling plate constantly. So a positive electrode conductor and a negative electrode conductor of a circuit board of a control base pass through the slots and contact with the positive electrode pin and the negative electrode pin of the luminous body respectively for connecting electrically.

Another object of the present invention is to provide a flashlight head with precise focus. A circuit board of a control base comprises a positive electrode conductor and a negative electrode conductor positioned corresponding to a positive electrode pin and a negative electrode pin of a luminous body respectively. The positive electrode conductor and the negative electrode conductor protrude from the circuit board and are conductive leaf springs or conductive coil springs for biasing toward the positive electrode pin and the negative electrode and connecting electrically.

Another object of the present invention is to provide a flashlight head with precise focus. A cooling plate comprises two slots positioned corresponding to a positive electrode pin and a negative electrode pin of a luminous body respectively. A positive electrode conductor and a negative electrode conductor pass through the slots and connect to a positive electrode pin and a negative electrode pin of a luminous body electrically while a control base installs within a project barrel. A shape of the slots is designed to prevent from contacting with the positive electrode conductor or the negative electrode conductor and avoid a short circuit.

Another object of the present invention is to provide a flashlight head with precise focus. Two slots formed on a cooling plate are disposed corresponding to a positive electrode pin and a negative electrode pin of a luminous body. The slots are round and a positive electrode conductor and a negative electrode conductor are conductive coil springs. Two insulating sleeves insert into the slots to prevent the slots from contacting with the positive electrode conductor or the negative electrode conductor and avoid a short circuit.

### BRIEF DESCRIPTION OF THE DRAWINGS

FIG. 1 is a schematic perspective view about the first embodiment of the present invention.

FIG. 2 is an exploded perspective view about the first embodiment of the present invention.

FIG. 3 is a front view about the flashlight head of the present invention.

FIG. 4 is a cross section view of FIG. 3, taking along the line B-B.

FIG. 5 is an exploded perspective view about the flashlight head of the present invention.

FIG. 6 is a top view about the flashlight head shown in FIG. 5, in which the control base and the cooling plate have been omitted.

FIG. 7 is a top view about the flashlight head shown in FIG. 6, in which the cooling plate has been added.

FIG. 8 is an exploded perspective view about the luminous body and the project barrel of the present invention.

FIG. 9 is an exploded perspective view about the flashlight head of the second embodiment of the present invention.

FIG. 10 is a cross section view about the flashlight head of the second embodiment of the present invention.

FIG. 11 is an exploded perspective view about the flashlight head of the third embodiment of the present invention.

FIG. 12 is a cross section view about the flashlight head of the third embodiment of the present invention.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

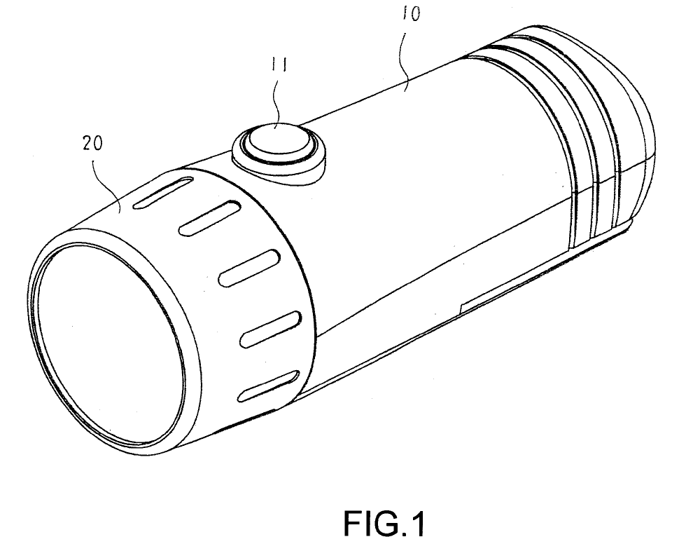

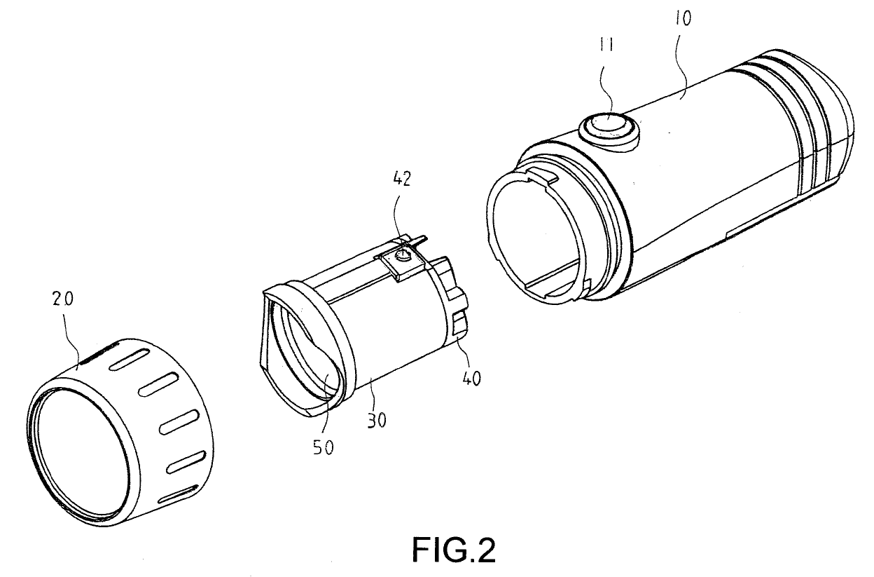

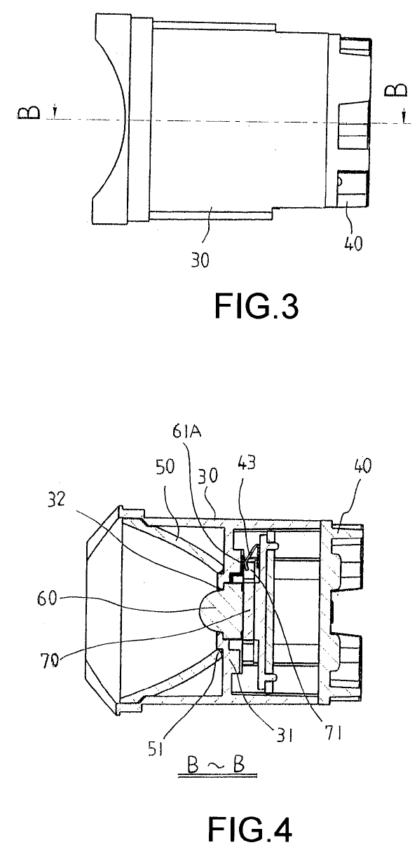

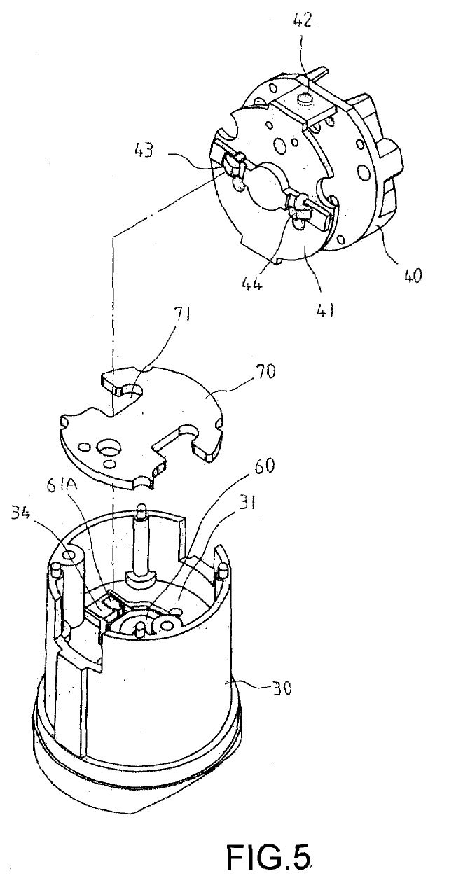

Referring to FIG. 1 and FIG. 2, a flashlight head according to the present invention is illustrated. A flashlight head positioned within a housing 10 at a front end thereof connects electrically to a battery and locks by a light-transmissible front cap 20. The flashlight head includes a project barrel 30 and a control base 40 as shown in FIG. 3, FIG. 4, and FIG. 5.

A project barrel 30 includes a reflector 50 positioned at a front end of the project barrel. An entry of a light source portion 51 at one end of the reflector 50 is mounted on a positioner 31. An opening 32 forms at a center of the positioner 31.

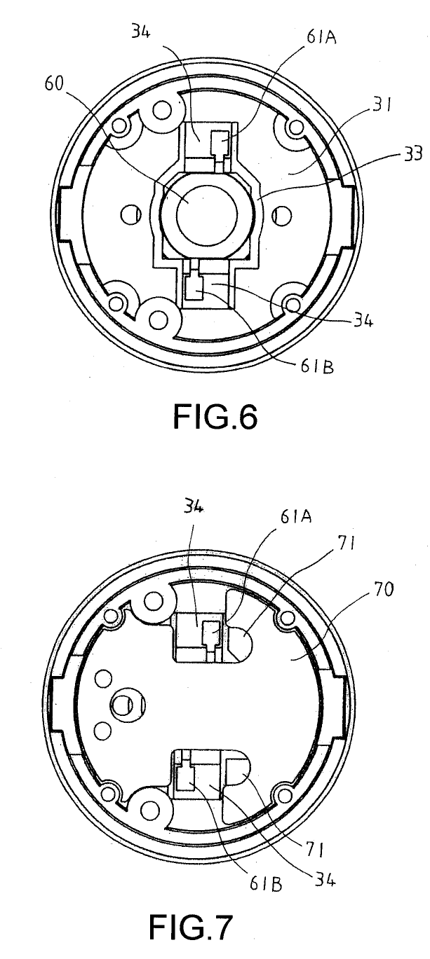

A luminous body 60 passes through the opening 32 and extends into a center of the entry of the light source portion 51 of the reflector 50. Referring to FIG. 5 and FIG. 6, the luminous body 60 includes a positive electrode pin 61A and a negative electrode pin 61B, and each of the positive electrode pin 61A and the negative electrode pin 61 B extends onto the positioner 31.

Referring to FIG. 4, FIG. 5, and FIG. 7, a cooling plate 70 is adhered to a back side of the luminous body 60. Two slots 71 form on the cooling plate 70 and is positioned corresponding to the positive electrode pin 61A and the negative electrode pin 61B respectively. So that the positive electrode pin 61A and the negative electrode pin 61B show from the slots 71.

Referring to FIG. 2, FIG. 5, and FIG. 7, a circuit board 41 is mounted on one end of the control base 40. The control base 40 includes a switch 42 positioned corresponding to a button 11 on the housing 10. A positive electrode conductor 43 and a negative electrode conductor 44 is mounted on the circuit board 41 and is positioned corresponding to the positive electrode pin 61A and the negative electrode pin 61B of the luminous body 60 respectively.

Referring to FIG. 2, FIG. 3, FIG. 4, FIG. 5, and FIG. 7, the positive electrode conductor 43 and the negative electrode conductor 44 pass through the slots 71 of the cooling plate 70 and connect electrically to the positive electrode pin 61A and the negative electrode pin 61B of the luminous body 60 respectively while the control base 40 assembles with the project barrel 30.

Referring to FIG. 1 and FIG. 2, the operation of the button 11 of the housing 10 will control the luminous body 60 through the circuit board 41 and the switch 42 of the control base 40 as shown in FIG. 5. Referring to FIG. 4, the luminous body 60 is disposed in the center of the project barrel 30 and the center of the entry of the light source portion 51 of the reflector 50, i.e. the focus of the flashlight, so the flashlight is assembling without calibrating the focus. The efforts of assembling easily and quickly and high quality are reached.

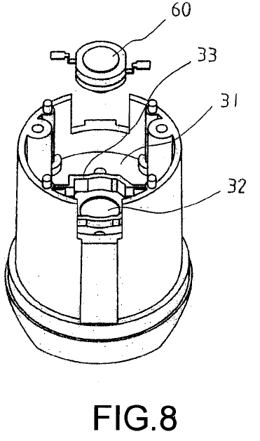

According to the first embodiment of the present invention, the entry of the light source portion 51 of the reflector 50 inside the project barrel 30 is mounted on the positioner 31 as shown in FIG. 4. The opening 32 forms at the center of the positioner 31 for assembling the luminous body 60 extending into the entry of the light source portion 51 and projecting the light. Referring to FIG. 6 and FIG. 8, a mounting frame 33 disposed around the opening 32 has a shape corresponding to the luminous body 60 for positioning the luminous body 60 and providing an effort of assembling easily and precisely.

Referring to FIG. 4, FIG. 5, and FIG. 6, the opening 32 forms at the center of the positioner 31 inside the project barrel 30 for assembling a luminous body 60. The positioner 31 comprises two installing surfaces 34 positioned corresponding to the positive electrode pin 61A and the negative electrode pin 61B of the luminous body 60 respectively. Referring to FIG. 7, the installing surfaces 34 position the positive electrode pin 61A and the negative electrode pin 61B respectively while the luminous body 60 is mounting in the opening 32 for ensuring the positive electrode pin 61A and the negative electrode pin 61B positioned corresponding to two slots 71 of the cooling plate 70 constantly. So the positive electrode conductor 43 and the negative electrode conductor 44 of the circuit board 41 of the control base 40 pass through the slots 71 and contact with the positive electrode pin 61A and the negative electrode pin 61B of the luminous body 60 respectively for connecting electrically.

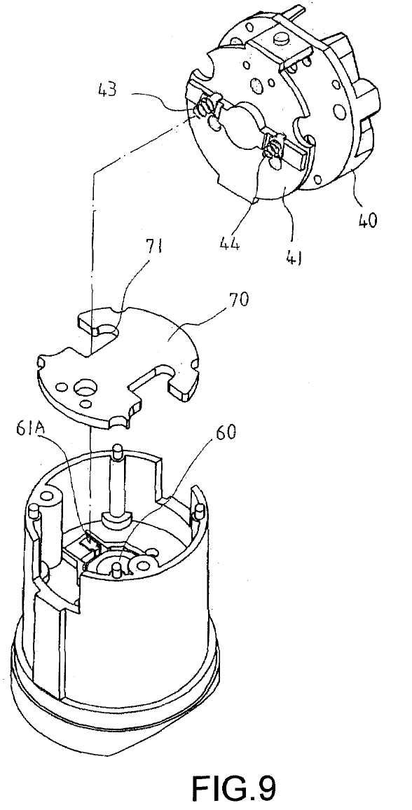

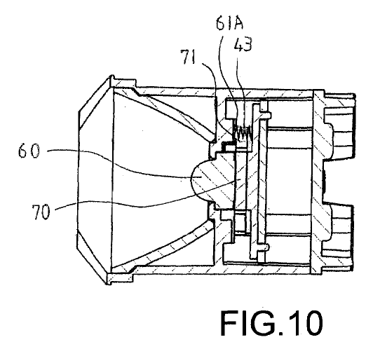

Referring to FIG. 5 and FIG. 7, the circuit board 40 of the control base 40 comprises the positive electrode conductor 43 and the negative electrode conductor 44 positioned corresponding to the positive electrode pin 61A and the negative electrode pin 61B of the luminous body 60 respectively. The positive electrode conductor 43 and the negative electrode conductor 44 protrude from the circuit board 41 and are conductive leaf springs as shown in FIG. 9 or conductive coil springs as shown in FIG. 4, FIG. 7, and FIG. 10 for biasing toward the positive electrode pin 61A and the negative electrode 62B and connecting electrically. Similarly, if the positive electrode pin 61A and the negative electrode 62B are conductive leaf springs or conductive coil springs extending through the slots 70, then the positive electrode conductor 43 and the negative electrode conductor 44 are contacting with them. It will acquire the equivalent result.

Referring to FIG. 4, FIG. 5, and FIG. 7, the cooling plate 70 comprises two slots 71 positioned corresponding to the positive electrode pin 61A and the negative electrode pin 61B of the luminous body 60 respectively. The positive electrode conductor 43 and the negative electrode conductor 44 pass through the slots 71 and connect to the positive electrode pin 61A and the negative electrode pin 61B of the luminous body 60 electrically while the control base 40 installs within the project barrel 30. A shape of the slots 71 is designed to prevent from contacting with the positive electrode conductor 43 or the negative electrode conductor 44 and avoid a short circuit.

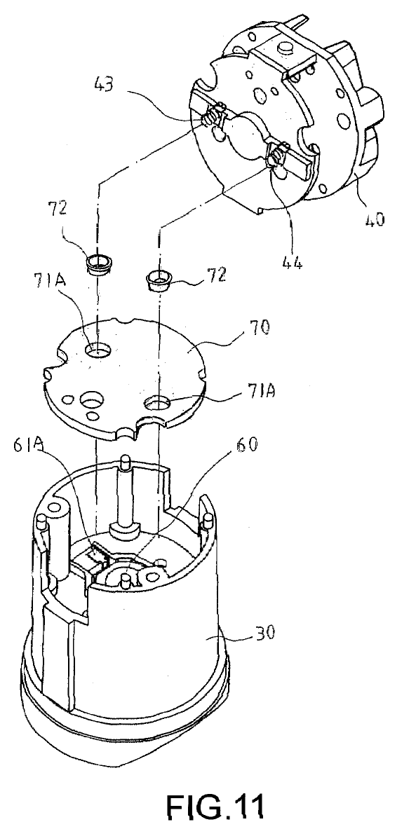

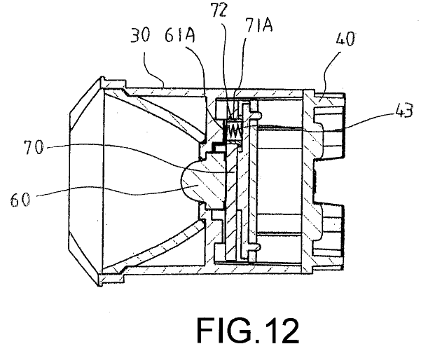

The area of the cooling plate 70 is enlarged in the third embodiment of the present invention. Referring to FIG. 11 and FIG. 12, two slots 71A formed on the cooling plate 70 are disposed corresponding to the positive electrode pin 61A and the negative electrode pin 61B of the luminous body 60. The slots 71A are round and the positive electrode conductor 43 and the negative electrode conductor 44 are conductive coil springs. Two insulating sleeves 72 insert into the slots 71A to prevent the slots 71A from contacting with the positive electrode conductor 43 or the negative electrode conductor 44 and avoid a short circuit.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flashlight head positioned within a housing at a front end thereof and connected electrically to a battery comprising:
a project barrel having a reflector, the reflector positioned at a front end of the project barrel and having a light source portion, the light source portion mounted on a positioner, an opening positioned at a center of the positioner;
a luminous body passing through the opening and extending into a center of the light source portion of the reflector, the luminous body having a positive electrode pin and a negative electrode pin, each of the positive electrode pin and the negative electrode pin extending onto the positioner;
a cooling plate adhered to a back side of the luminous body; two slots formed on the cooling plate and positioned corresponding to the positive electrode pin and the negative electrode pin;
a control base having a switch positioned corresponding to a button on the housing; a circuit board mounted on one end of the control base; a positive electrode conductor and a negative electrode conductor mounted on the circuit board and positioned corresponding to the positive electrode pin and the negative electrode pin of the luminous body respectively; and
wherein the positive electrode conductor and the negative electrode conductor pass through the slots of the cooling plate and connect electrically to the positive electrode pin and the negative electrode pin of the luminous body respectively while the control base assembles with the project barrel.

2. The flashlight head as claimed in claim 1, wherein the positioner further comprises a mounting frame positioned around the opening, the mounting frame has a shape corresponding to the luminous body for positioning the luminous body and providing an effort of assembling easily and precisely.

3. The flashlight head as claimed in claim 1, wherein the positioner further comprises two installing surfaces positioned corresponding to the positive electrode pin and the negative electrode pin of the luminous body respectively, the installing surfaces position the positive electrode pin and the negative electrode pin respectively for ensuring the positive electrode pin and the negative electrode pin contact with the positive electrode conductor and the negative electrode conductor.

4. The flashlight head as claimed in claim 1, wherein the positive electrode conductor and the negative electrode conductor are conductive leaf springs or conductive coil springs for biasing toward the positive electrode pin and the negative electrode pin respectively.

5. The flashlight head as claimed in claim 1, wherein a shape of the slots of the cooling plate is designed to prevent from contacting with the positive electrode conductor or the negative electrode conductor and avoid a short circuit.

6. The flashlight head as claimed in claim 1, wherein the slots of the cooling plate are round and the positive electrode conductor and the negative electrode conductor are conductive coil springs, two insulating sleeves insert into the slots to prevent the slots from contacting with the positive electrode conductor or the negative electrode conductor and avoid a short circuit.
